(19) United States
(12) Patent Application Publication
(10) Pub. No.: US 2007/0214004 A1
(43) Pub. Date: Sep. 13, 2007

(54) System and method for managing the lifecycle of a patent case

(75) Inventors: Chung-I Lee, Tu-Cheng (TW); Hai-Hong Lin, Shenzhen (CN); De-Yi Xie, Shenzhen (CN); Hai-Yun Chen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,865

(22) Filed: Oct. 16, 2006

(30) Foreign Application Priority Data
Jan. 16, 2006 (CN) 200610033107.1

(51) Int. Cl. G06Q 10/00; G06Q 50/00

(52) U.S. Cl. 705/2

(57) ABSTRACT

A method for managing the lifecycle of a patent case is disclosed. The method includes the steps of: uploading files of the patent case, and saving the uploaded files; analyzing the saved files to confirm the last completed control proceeding of the patent case; updating status of the patent case; generating a current control proceeding and a control date for the current control proceeding; assigning one or more undertakers to be in charge of the current control proceeding of the patent case; and system checking. A related system is also disclosed.

### FIELD OF THE INVENTION

The present invention generally relates to a system and method for lifecycle management, and more particularly, to a system and method for managing the lifecycle of a patent case.

### DESCRIPTION OF RELATED ART

As competition grows more fierce by the day, to remain competitive, innovations in technology have become one focus of attention.

Today, patent is the most powerful weapon in protecting innovations in technology. From a small unit, an enterprise to a big country, to possess core patents is the leading card, which plays a crucial role in winning competitions. Therefore, patent quantity and patent quality are important indexes, usually used to measure the ability of innovation of a unit, an enterprise or a country.

Nevertheless, for a patent case, the lifecycle is comparatively long, during which there are many complicated proceedings. However, by far, there is no effective system or method, which can manage the lifecycle of a patent case automatically. It is very laborious and time-consuming to manage the patent case by manual tasks still.

What is needed, therefore, is a system and method which can manage the lifecycle of a patent case automatically, for the sake of reducing labor intensity and enhancing work efficiency.

### SUMMARY OF THE INVENTION

One preferred embodiment provides a system for managing the lifecycle of a patent case. The system includes a transmitting module, a saving module, an analyzing module, a generating module, a processing module and a judging module. The transmitting module is configured for uploading files of the patent case. The saving module is configured for saving the uploaded files. The analyzing module is configured for analyzing the saved files to confirm the last completed control proceeding of the patent case. The generating module is configured for generating a current control proceeding and a control date for the current control proceeding. The processing module is configured for assigning one or more undertakers to be in charge of the current control proceeding of the patent case. The judging module is configured for determining whether the current control proceeding affects control proceedings of other patent cases which are in a same patent family with the patent case, and for determining whether there are false control dates for all the control proceedings of the patent case or whether there are control dates to be overdue.

Another preferred embodiment provides a method for managing the lifecycle of a patent case. The method includes the steps of: (a) uploading files of the patent case, and saving the uploaded files; (b) analyzing the saved files to confirm the last completed control proceeding of the patent case; (c) updating status of the patent case; (d) generating a current control proceeding and a control date for the current control proceeding; (e) assigning one or more undertakers to be in charge of the current control proceeding of the patent case; (f) system checking.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration and an application environment of a system for managing the lifecycle of a patent case in accordance with a preferred embodiment;

FIG. 2 is a schematic diagram of main function modules of the system of FIG. 1;

FIG. 3 is a flow chart of a preferred method for managing the lifecycle of a patent case by utilizing the system of FIG. 1; and

FIG. 4 is a flow chart of details of one step of FIG. 3, namely system checking.

### DETAILED DESCRIPTION OF THE INVENTION

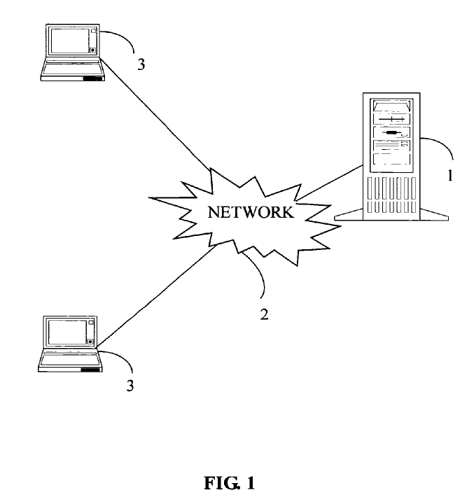

FIG. 1 is a schematic diagram of hardware configuration and an application environment of a system for managing the lifecycle of a patent case in accordance with a preferred embodiment. The application environment may typically include a server 1 and at least one client computer 3 (only two shown). The client computers 3 are connected to the server 1 via a network 2.

The client computer 3 includes a system for managing the lifecycle of a patent case (hereinafter “the system 10”), and provides a graphics user interface (GUI). By using the GUI, information of all the patent cases can be conveniently viewed by a patent agent or a patent engineer in a corporation.

The network 2 is an electronic network, which may be the Internet, an Intranet, or any other type of network.

The server 1 is used for saving all uploaded files, control proceedings and respective control dates, and undertakers of different control proceedings during the lifecycle of a patent case. The control proceedings may include, but not limited to, opening a file, drafting a patent application, submitting an information disclosure statement (IDS), responding to an office action, paying issue fees and paying maintenance fees.

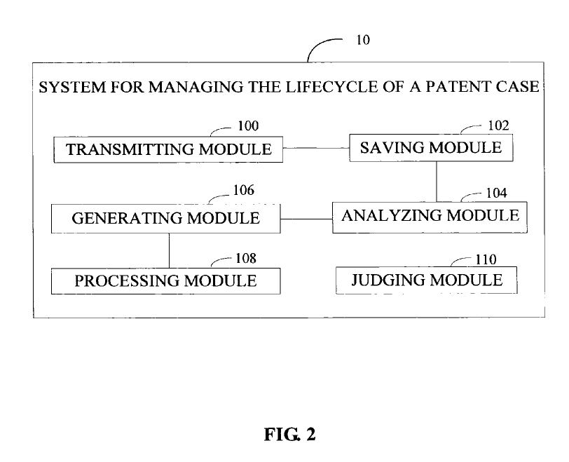

FIG. 2 is a schematic diagram of main function modules of the system 10. The system 10 mainly includes a transmitting module 100, a saving module 102, an analyzing module 104, a generating module 106, a processing module 108 and a judging module 110.

The transmitting module 100 is configured for uploading files of the patent case from the client computers 3 to the server 1. The files uploaded include external files and internal files. The external files include files from government patent offices, such as the United States Patent and Trademark Office (USPTO), the European Patent Office (EPO), the State Intellectual Property Office of the People's Republic of China (SIPO), and the Japanese Patent Office (IPO). The internal files include files from patent agency itself.

The saving module 102 can save all the files uploaded, status of the patent case, the last completed control proceeding, a current control proceeding, undertakers and control dates of different control proceedings, and so on in the server 1.

The analyzing module 104 is configured for analyzing the saved files so as to confirm the last completed control proceeding. For example, if the files saved by the saving module 102 are specification and drawings of a patent case, the analyzing module 104 analyzes the above files, and confirms the last completed control proceeding as: drafting a patent application.

The generating module 106 is configured for generating a current control proceeding according to the last control proceeding confirmed by the analyzing module 104. The generating module 106 can also generate a control date for the current control proceeding.

The processing module 108 is configured for assigning one or more undertakers to be in charge of the current control proceeding of the patent case, and for updating the status of the patent case. The processing module 108 is also configured for correcting false control dates of the control proceedings. Generally, statuses of a patent case in its lifecycle include: processing, examining, pending, waiting for a certificate, maintaining, closed and expired.

The judging module 110 is configured for determining whether the current control proceeding affects control proceedings of other patent cases which are in a same patent family with the patent case, and for determining whether there are false control dates for all the control proceedings of the patent case or whether there are control dates to be overdue. The patent family here refers to different patent cases generated by a same technology, in case that the technology is applied for patents in different countries or regions. The patent that is filed first in time is regarded as a basic patent for other patents in the patent family.

The generating module 106 is also configured for generating the control proceedings of other patent cases, in case the current control proceeding affects control proceedings of other patent cases in the same patent family.

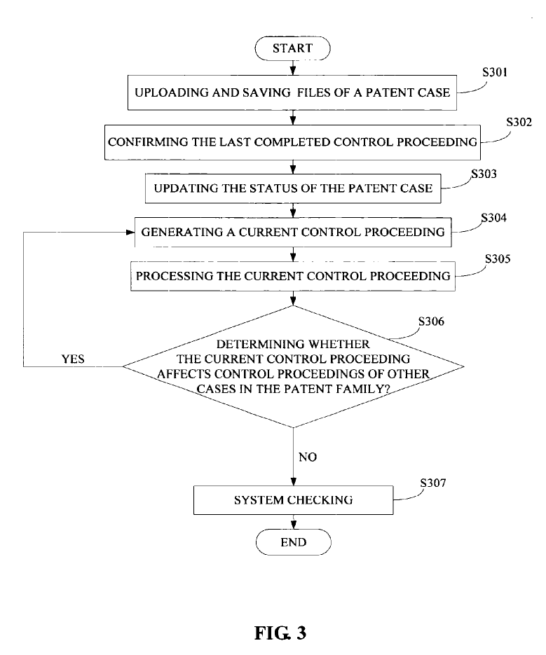

FIG. 3 is a flow chart of a preferred method for managing the lifecycle of a patent case by utilizing the system 10.

In step S301, the transmitting module 100 uploads files of the patent case from the client computers 3 to the server 1, then, the saving module 102 saves the uploaded files.

In step S302, the analyzing module 104 analyzes the saved files so as to confirm the last completed control proceeding of the patent case. Subsequently, the saving module 102 saves the last completed control proceeding and a corresponding completed date.

In step S303, the processing module 108 updates status of the patent case according to the last completed control proceeding confirmed by the analyzing module 104. Then the saving module 102 saves the updated status. For instance, if the analyzing module 104 confirms the last completed control proceeding as drafting a patent application, the processing module 108 updates the status as processing; if the analyzing module 104 confirms the last completed control proceeding as responding to an office action, the processing module 108 updates the status as examining or pending.

In step S304, the generating module 106 generates a current control proceeding and a control date for the current control proceeding, according to the last completed control proceeding confirmed by the analyzing module 104. Subsequently, the saving module 102 saves the current control proceeding and a corresponding control date. For example, if the analyzing module 104 confirms the last completed control proceeding as opening a file, the generating module 106 generates the current control proceeding: drafting a patent application.

In step S305, the processing module 108 assigns one or more undertakers to be in charge of the current control proceeding of the patent case, and then the saving module 102 records the assigned undertakers.

In step S306, the judging module 110 determines whether the current control proceeding affects control proceedings of other patent cases which are in a same patent family with the patent case. If the current control proceeding affects control proceedings of other patent cases in the same patent family, the procedure returns to the step S304, the generating module 106 generates control proceedings of other patent cases. Otherwise, if the current control proceeding doesn't affect control proceedings of other patent cases in the same patent family, in step S307, system checks timely.

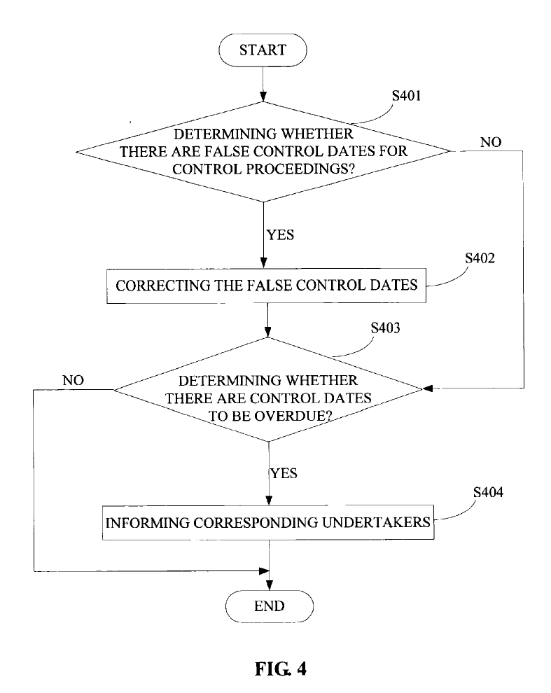

FIG. 4 is a flow chart of details of step S307, namely system checking.

In step S401, the judging module 110 determines whether there are false control dates for the control proceedings. If there are false control dates, in step S402, the processing module 108 corrects the false control dates, and the saved module 102 saved the corrected control dates in the server 1. Otherwise, the procedure jumps to the step S403.

In step S403, the judging module 110 determines whether there are control dates to be overdue in the saved control dates. If there are control dates to be overdue, in step S404, the processing module 108 informs corresponding undertakers to process the patent case. Otherwise, the procedure ends.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for managing the lifecycle of a patent case, the system comprising:
a transmitting module configured for uploading files of the patent case;
a saving module configured for saving the uploaded files;
an analyzing module configured for analyzing the saved files to confirm the last completed control proceeding of the patent case;
a generating module configured for generating a current control proceeding and a control date for the current control proceeding;
a processing module configured for assigning one or more undertakers to be in charge of the current control proceeding of the patent case; and
a judging module configured for determining whether the current control proceeding affects control proceedings of other patent cases which are in a same patent family with the patent case, and configured for determining whether there are false control dates for all the control proceedings of the patent case or whether there are control dates to be overdue.

2. The system according to claim 1, wherein the control proceedings include opening a file, drafting a patent application, submitting an information disclosure statement (IDS), responding to an office action, paying issue fees and paying maintenance fees.

3. The system according to claim 1, wherein the generating module is further configured for generating the control proceedings of other patent cases in the same patent family.

4. The system according to claim 1, wherein the processing module is further configured for updating status of the patent case and correcting the false control dates.

5. The system according to claim 4, wherein the status of the patent case includes: processing, examining, pending, waiting for a certificate, maintaining, closed or expired.

6. A method for managing the lifecycle of a patent case, the method comprising the steps of:
uploading files of the patent case, and saving the uploaded files;
analyzing the saved files to confirm the last completed control proceeding of the patent case;
updating status of the patent case;
generating a current control proceeding and a control date for the current control proceeding;
assigning one or more undertakers to be in charge of the current control proceeding of the patent case; and
system checking.

7. The method according to claim 6, further comprising the step of:
determining whether the current control proceeding affects control proceedings of other patent cases which are in a same patent family with the patent case.

8. The method according to claim 7, wherein the determining step comprises the steps of:
returning to the generating step if the current control proceeding affects the control proceedings of other patent cases in the same patent family; and
going directly to the system checking step if the current control proceeding dose not affect the control proceedings of other patent cases in the same patent family.

9. The method according to claim 6, wherein the step of system checking comprises the steps of:
determining whether there are false control dates for the control proceedings;
correcting the false control dates if the false control dates exist;
determining whether there are control dates to be overdue; and
informing corresponding undertakers to process the patent case if there are control dates to be overdue.
